(19) United States
(12) Patent Application Publication
(10) Pub. No.: US 2018/0342955 A1
(43) Pub. Date: Nov. 29, 2018

(54) SECOND BOOST CIRCUIT FOR DC VOLTAGE INPUT

(71) Applicant: Chicony Power Technology Co., Ltd., New Taipei City (TW)

(72) Inventor: Hsien-Yi TSAI, New Taipei City (TW)

(21) Appl. No.: 15/683,003

(22) Filed: Aug. 22, 2017

(30) Foreign Application Priority Data
May 26, 2017 (TW) 106117630

(51) Int. Cl. H02M 3/335; H02M 1/08

(52) U.S. Cl. CPC H02M 3/33523; H02M 1/08

(57) ABSTRACT

A second boost circuit for a DC voltage input converts a DC input voltage into to a DC output voltage, and the second boost circuit includes a bypass unit, a boost unit, and a detection control unit. When the DC input voltage is less than a threshold voltage, the bypass unit is disconnected. The detection control unit controls the boost unit to convert the DC input voltage into to the DC output voltage according to a boost ratio, thereby maintaining the DC output voltage higher than a predetermined voltage value during a hold-up time.

### BACKGROUND

### Technical Field

The present invention relates to a second boost circuit for a DC voltage input, especially to a second boost circuit providing a boost operation to maintain a DC output voltage within a normal range when the DC input voltage is lower than a threshold voltage.

### Description of Related Art

In recent years, the requirement for the power supply device is increased with the demand of the power quality in order to stabilize the power quality for the electronic products due to the growing popularity of electronic products. During the operation of the power supply device supplying power to the electronic products, if the power supply device is off, the power supply device must be able to be maintained outputting power for a period of time so that the electronic products may have enough time to respond, and completely store or backup data before power off. Otherwise, if the power supply device cannot output power steadily for a period of time after power off, the electronic products may thus have no time to respond, and result in information loss or damage of the electronic products.

Specifically, after the power supply device is off, the time of the remained power supply mainly depends on the bulk capacitance of the power supply. In order to effectively extend the time of the remained power provided by the power supply device after power off, the capacity of the power supply device is increased to extend the time of the remained power after power off because the higher capacity provides longer time for providing power. However, the volume and the size of the power supply apparatus are thus increased.

Therefore, a second boost circuit designed to provide the boost operation to extend the time of the remained power provided by the power supply device after power off, and achieve the minimization of the volume of the power supply device is an important solution.

### SUMMARY

Accordingly, the present invention provides a second boost circuit used for a DC voltage input to solve the aforementioned issue. The second boost circuit includes: a bypass unit having an input end and an output end, the input end being coupled to a first capacitor, the output end being coupled to a second capacitor, wherein the first capacitor receives a DC input voltage; a boost unit having a primary side and a secondary side, the primary side being coupled to the first capacitor, the secondary side being coupled to the second capacitor, wherein the primary side has a first inductive element, the secondary side has a second inductive element, a boost ratio is provided between the second inductive element and the first inductive element; and a detection control unit detecting the DC input voltage. When the DC input voltage is lower than a threshold voltage, the bypass unit is disconnected, and the detection control unit controls the boost unit to convert the DC input voltage into a DC output voltage according to the boost ratio.

In an embodiment, the detection control unit controls the boost unit to maintain the DC output voltage higher than a predetermined voltage during a hold-up time.

In an embodiment, when the DC input voltage is higher than or equal to the threshold voltage, the bypass unit is connected, and the detection control unit disconnects the boost unit so that the DC input voltage is provided to the DC output voltage.

In a first embodiment, the boost unit includes: a first switch; a first coil located at the primary side, and the first coil coupled to the first capacitor at one end of the first coil and coupled to the first switch at the other end of the first coil; and a second coil located at the secondary side, and the second coil coupled to the first coil at one end of the second coil and coupled to the second capacitor at the other end of the second coil. The first coil and the second coil form an autotransformer topology, a turn ratio between a turn difference of the second coil and the first coil turn and the first coil turn is the boost ratio, when the detection control unit outputs a control signal to control the first switch, therefore the DC input voltage is boosted to be the DC output voltage based on the turn ratio.

In an embodiment, the bypass unit includes: a first diode coupled to the first capacitor at one end of the first diode and coupled to the second capacitor at the other end of the first diode; a second switch coupled to the first diode in parallel; and a first control unit coupled to the first diode in parallel; wherein the first control unit turns on or turns off the second switch according to the DC input voltage and the DC output voltage; when the DC input voltage is higher than the DC output voltage, the first control unit turns on the second switch; when the DC input voltage is lower than the DC output voltage, the first control unit turns off the second switch.

In an embodiment, the detection control unit includes: a detection unit coupled to the first capacitor; and a second control unit coupled to the detection unit and the boost unit. The detection unit detects the DC input voltage, and outputs a detection signal to the second control unit according to the DC input voltage, and when the DC input voltage is lower than the threshold voltage, the second control unit outputs a control signal to the boost unit.

In a second embodiment, the boost unit includes: a first switch; a first coil located at the primary side, and the first coil coupled to the first capacitor at one end of the first coil and coupled to the first switch at the other end of the first coil; and a second coil located at the secondary side, and the second coil coupled to the second capacitor. The first coil is isolated from the second coil, a turn ratio between the second coil and the first coil is the boost ratio, when the detection control unit outputs a control signal to turn off the first switch, the DC input voltage is boosted to be the DC output voltage based on the turn ratio.

In a second embodiment, the first coil and the second coil form a subtractive polarity transformer topology.

In an embodiment, the second boost circuit further includes: a buffer circuit coupled to the boost unit and the first capacitor for restraining an impulse voltage generated from the boost unit operating.

In an embodiment, the buffer circuit includes: a capacitor coupled to the first capacitor; a resistor coupled to the capacitor in parallel; and a second diode coupled to the capacitor and the boost unit. When the boost unit generates the impulse voltage, the resistor and the capacitor are provided to restrain a voltage peak value of the impulse voltage.

It is to be understood that both the foregoing general description and the following detailed description are exemplary, and are intended to provide further explanation of the present invention as claimed. Other advantages and features of the present invention will be apparent from the following description, drawings and claims.

### BRIEF DESCRIPTION OF DRAWING

The present invention can be more fully understood by reading the following detailed description of the embodiment, with reference made to the accompanying drawings as follows:

FIG. 1 shows a circuit block diagram of a second boost circuit according to a first embodiment of the present invention.

FIG. 2 shows a timing waveform diagram of the second boost circuit according to the present invention.

FIG. 3A shows a circuit diagram of a boost unit according to the first embodiment of the present invention.

FIG. 3B shows a circuit diagram of the boost unit according to a second embodiment of the present invention.

FIG. 4 shows a circuit diagram of a bypass unit according to the present invention.

FIG. 5 shows a circuit block diagram of a detection control unit according to the present invention.

FIG. 6 shows a circuit diagram of a buffer circuit according to the present invention.

FIG. 7 shows a circuit block diagram of the second boost circuit according to the second embodiment of the present invention.

### DETAILED DESCRIPTION

Reference will now be made to the drawing figures to describe the present invention in detail. It will be understood that the drawing figures and exemplified embodiments of present invention are not limited to the details thereof.

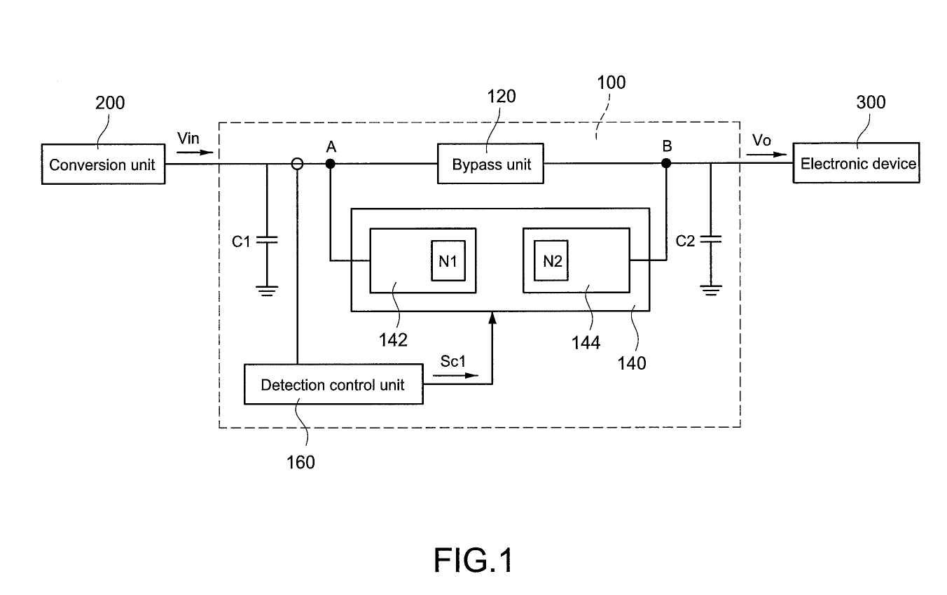

Please refer to FIG. 1, which shows a circuit block diagram of a second boost circuit according to a first embodiment of the present invention. A second boost circuit 100 may be applied, but not limited, to a power supply device. The second boost circuit 100 receives a DC input voltage Vin provided by a front-stage conversion unit 200, converts the DC input voltage Vin into a DC output voltage Vo, and further outputs the DC output voltage Vo to supply power to a rear-stage electronic device 300 coupled to the second boost circuit 100. As shown in FIG. 1, the second boost circuit 100 includes a bypass unit 120, a boost unit 140, a detection control unit 160, a first capacitor C1 and a second capacitor C2. The first capacitor C1 receives the DC input voltage Vin, and the first capacitor C1 of the second boost circuit 100 stores and stabilizes the DC input voltage Vin. The second capacitor C2 receives the DC output voltage Vo, and the second capacitor C2 of the second boost circuit 100 stores and stabilizes the DC output voltage Vo. The bypass unit 120 has an input end A and an output end B. The bypass unit 120 is coupled to the first capacitor C1 at the input end A and coupled to the second capacitor C2 at the output end B. The boost unit 140 is coupled to the bypass unit 120 in parallel, that is, an input side of the boost unit 140 is coupled to the first capacitor C1 and the input end A of the bypass unit 120, and an output side of the boost unit 140 is coupled to the second capacitor C2 and the output end B of the bypass unit 120. The detection control unit 160 is coupled to the first capacitor C1, and the detection control unit 160 detects the DC input voltage Vin and controls the boost unit 140 according to the DC input voltage Vin.

Specifically, the voltages at the input end A and the output end B determine whether the bypass unit 120 is connected or disconnected. When the DC input voltage Vin at the input end A of the bypass unit 120 is higher than the DC output voltage Vo at the output end B, the bypass unit 120 is connected. At this condition, the second capacitor C2 is charged by the DC input voltage Vin through the bypass unit 120 to provide the DC output voltage Vo. Otherwise, when the DC input voltage Vin at the input end A of the bypass unit 120 is lower than the DC output voltage Vo at the output end B, the bypass unit 120 is disconnected. At this condition, the second capacitor C2 cannot be charged by the DC input voltage Vin through the bypass unit 120. It also should be noted that, the higher than or lower than relationship of voltage is described in the present invention, but the equal relationship is not excluded, the description only expresses two voltages with relative values corresponding to connected and disconnected operation respectively. In other words, in the present invention, one voltage may be “lower than or equal to” and the other voltage may be “higher than” express two relative value relationships, or one voltage may be “higher than or equal to” and the other voltage may be “lower than” also express two relative value relationships. Thus, it should be known that the “higher than” and “lower than” are not used for limiting voltage relationships in the present invention.

Furthermore, when the front-stage conversion unit 200 coupled to the second boost circuit 100 normally supplies power, the DC input voltage Vin is higher than or equal to a threshold voltage Vt. At this condition, the bypass unit 120 compares the DC input voltage Vin with the DC output voltage Vo. When the DC input voltage Vin is higher than the DC output voltage Vo, the bypass unit 120 is connected, and the DC input voltage Vin is transmitted by a path from the input end A to output end B of the bypass unit 120 to provide the DC output voltage Vo. When the DC input voltage Vin is lower than the DC output voltage Vo, the bypass unit 120 is disconnected, and the DC input voltage Vin cannot be transmitted by the path from the input end A to output end B of the bypass unit 120 to provide the DC output voltage Vo. When the front-stage conversion unit 200 coupled to the second boost circuit 100 is off, the DC input voltage Vin will become smaller gradually till the DC input voltage Vin is lower than the threshold voltage Vt. The second boost circuit 100 enables the boost operation by the boost unit 140 to convert the DC input voltage Vin into the DC output voltage Vo. Therefore, when the DC input voltage Vin is lower than the threshold voltage Vt, during the boost operation of the boost unit 140, the DC input voltage Vin is maintained lower than the DC output voltage Vo so that the bypass unit 120 is maintained disconnected.

Refer to FIG. 1 again, the boost unit 140 has a primary side 142 and a secondary side 144. The boost unit 140 is coupled to the first capacitor C1 at the primary side 142, and the boost unit 140 is coupled to the second capacitor C2 at the secondary side 144. The primary side 142 of the boost unit 140 has a first inductive element N1, the secondary side 144 of the boost unit 140 has a second inductive element N2, and a boost ratio Mb between the first inductive element N1 and the second inductive element N2 may be provided for the boost operation of the boost unit 140. The detection control unit 160 detects the DC input voltage Vin, and the detection control unit 160 outputs a first control signal Sc1 to control (enable or disable) the boost unit 140 according to the DC input voltage Vin. When the detection control unit 160 detects that the DC input voltage Vin is higher than or equal to the threshold voltage Vt, the detection control unit 160 will not output the first control signal Sc1, or output the first control signal Sc1 with a disabled level (such as a low level) to the boost unit 140, thereby disabling the boost unit 140. When the detection control unit 160 detects that the DC input voltage Vin is lower than the threshold voltage Vt, the detection control unit 160 outputs the first control signal Sc1, or outputs the first control signal Sc1 with an enabled level (such as a high level) to the boost unit 140, thereby enabling the boost unit 140. At this condition, the boost unit 140 converts the DC input voltage Vin into the DC output voltage Vo based on the boost ratio Mb according to the first control signal Sc1 so as to maintain the DC output voltage Vo higher than the predetermined voltage Vp during the hold-up time T.

Furthermore, when the front-stage conversion unit 200 coupled to the second boost circuit 100 is off, the DC input voltage Vin of the first capacitor C1 will decrease gradually. Correspondingly, the DC output voltage Vo of the second capacitor C2 under no boost operation will finally decrease to 0V with the decreasing DC input voltage Vin. The decreasing of speed in the DC input voltage Vin and that of the DC output voltage Vo depend on the first capacitor C1 and the second capacitor C2 respectively. When the capacitance of the first capacitor C1 and that of the second capacitor C2 are too small, the DC input voltage Vin and the DC output voltage Vo will decrease fast so that the abnormal DC output voltage Vo may damage the rear-stage electronic device 300 or cause the rear-stage electronic device 300 not to store or backup data completely. Therefore, when the DC input voltage Vin decreases to lower than the threshold voltage Vt, the second boost circuit 100 converts the DC input voltage Vin into the DC output voltage Vo by the boost unit 140 to maintain the DC output voltage Vo higher than the predetermined voltage Vp during the hold-up time T so that the DC input voltage Vin and the DC output voltage Vo will not decrease fast, thereby avoiding the above-mentioned problems. Besides, since the second boost circuit 100 may convert the DC input voltage Vin into the DC output voltage Vo by the boost unit 140 and maintain the DC output voltage Vo higher than predetermined voltage Vp during the hold-up time T, the first capacitor C1 and the second capacitor C2 with greater capacitance are not required to prevent the DC input voltage Vin and the DC output voltage Vo from decreasing fast. In this way, the size and the volume of the first capacitor C1 and the second capacitor C2 may be smaller, and the circuit volume of the front-stage conversion unit 200 and the rear-stage electronic device 300 may be further smaller.

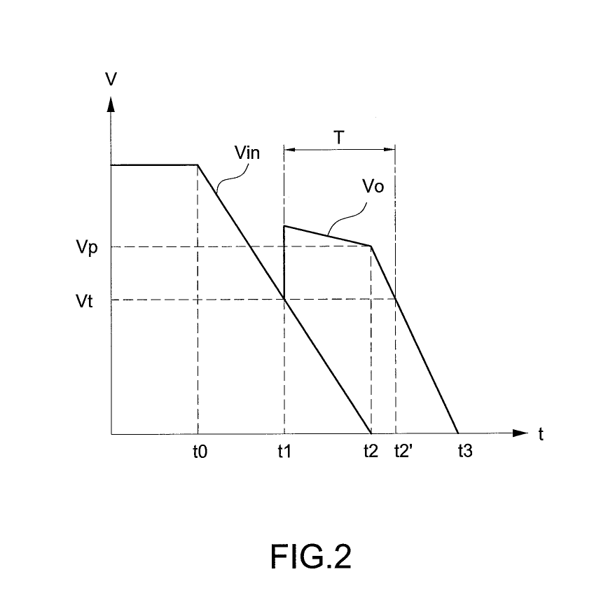

Please refer to FIG. 2, which shows a timing waveform diagram of the second boost circuit according to the present invention. Refer also to FIG. 1, at time t0, the front-stage conversion unit 200 coupled to the second boost circuit 100 is off, at this time, the DC input voltage Vin decreases gradually. Because the boost unit 140 has not performed the boost operation, the DC output voltage Vo also decreases with the DC input voltage Vin. At time t1, the DC input voltage Vin decreases to the threshold voltage Vt. At this time, the boost unit 140 starts operating, and the boost unit 140 converts the DC input voltage Vin into the DC output voltage Vo higher than the predetermined voltage Vp by the boost ratio Mb. At time t2, since the DC input voltage Vin has decreased to 0V, the converted DC output voltage Vo by the boost unit 140 fails to keep normal power supply. Thus, after time t2, the DC output voltage Vo decreases obviously, and decreases to lower than the predetermined voltage Vp at time t2′. As shown in FIG. 2, the DC input voltage Vin is lower than the threshold voltage Vt after time t1, and the boost operation of the boost unit 140 makes the DC output voltage Vo maintain normal power supply. After the DC input voltage Vin decreases to 0V, the DC output voltage Vo is lower than the predetermined voltage Vp after time t2′, and the normal power supply is stopped. In other words, during time t1 to time t2′, the DC output voltage Vo may maintain power supply for the normal operation of the rear-stage electronic device 300, therefore, the period of time t1 to time t2′ is defined as the hold-up time T. The second boost circuit 100 may maintain the DC output voltage Vo higher than the predetermined voltage Vp during the hold-up time T so that the DC output voltage Vo decreases to 0V after an extended period of time compared to the DC input voltage Vin (a period of time t2-t3, i.e. at time t3, the DC output voltage Vo and the DC input voltage Vin are both 0V). Therefore, the electronic device 300 may be turned off by the conversion unit 200 after the extended hold-up time T.

It should be mentioned that, in the embodiment, the threshold voltage Vt is provided to maintain the lowest voltage for the normal operation of the rear-stage electronic device 300, and to determine whether the boost unit 140 starts the boost operation, the value of the threshold voltage Vt is thus not limited. In other words, as long as threshold voltage Vt for operation of various rear-stage electronic devices 300 can be maintained, it is within the scope of the embodiment. Besides, the predetermined voltage Vp is provided to avoid the fluctuating voltage lower than the threshold voltage Vt, the value of the predetermined voltage Vp is thus not limited. In other words, the predetermined voltage Vp should be determined at least not be lower than the threshold voltage Vt to maintain the power for normal operation of the rear-stage electronic device 300 when the predetermined voltage Vp is varied.

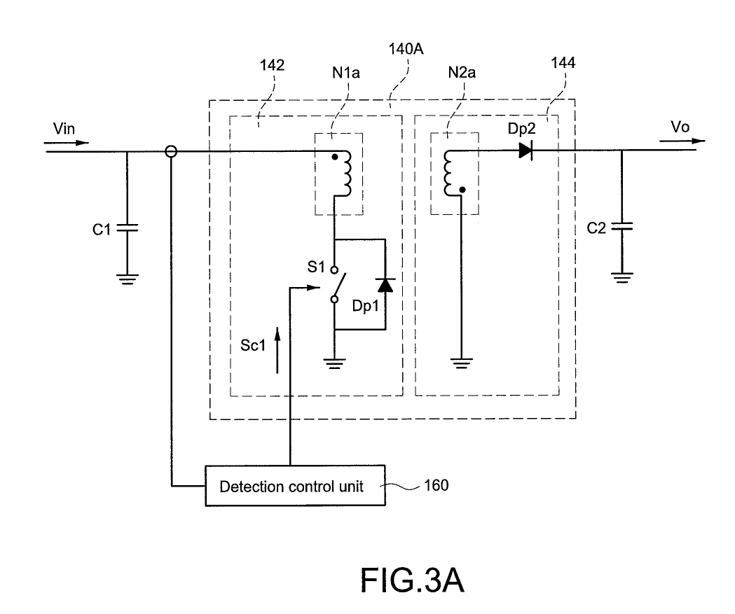

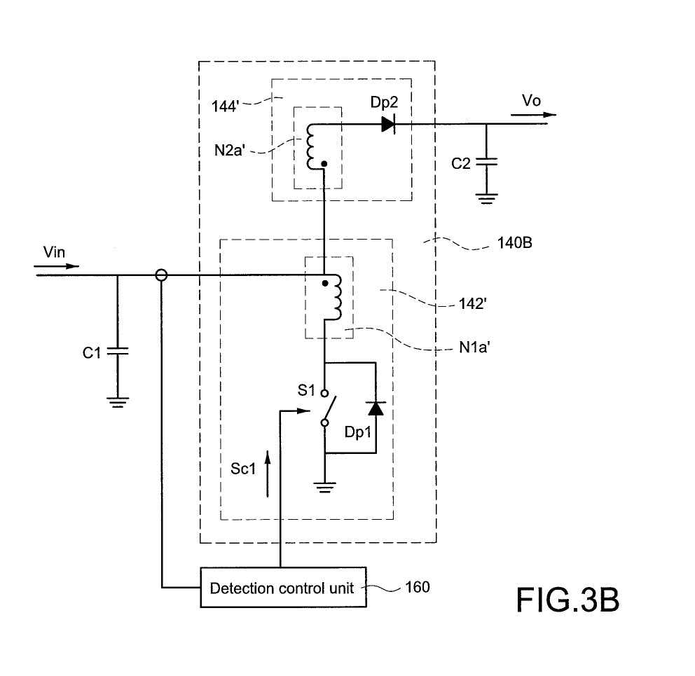

Please refer to FIG. 3A, which shows a circuit diagram of a boost unit according to the first embodiment of the present invention. Refer also to FIG. 1, the primary side 142 of the boost unit 140A includes a first switch S1 and a first coil N1a, and the secondary side 144 of the boost unit 140A includes a second coil N2a. The first coil N1a is coupled to the first capacitor C1 at one end of the first coil N1a, and coupled to the first switch S1 at the other end. The second coil N2a is coupled to the second capacitor C2, and the first coil N1a is isolated from the second coil N2a. The turn ratio between the second coil N2a and the first coil N1a is: N2a/N1a>1, and the turn ratio between the second coil N2a and the first coil N1a is the boost ratio Mb, that is, Mb=N2a/N1a. The detection control unit 160 controls the first switch S1 by the first control signal Sc1, that is, continuously controls the boost unit 140A in connection and disconnection to convert the DC input voltage Vin into the DC output voltage Vo based on the boost ratio Mb, namely the turn ratio between the second coil N2a and the first coil N1a. The boost unit 140A further includes a first protection diode Dp1 and a second protection diode Dp2, a cathode of the first protection diode Dp1 is coupled to an end of the first switch S1 and the first coil N1a, and an anode of the first protection diode Dp1 is coupled to the other end of the first switch S1 and the ground. A cathode of the second protection diode Dp2 is coupled to the second capacitor C2, and an anode of the second protection diode Dp2 is coupled to the second coil N2a. When the detection control unit 160 controls the first switch S1 in connection or disconnection by the first control signal Sc1, the boost unit 140A avoids the current reversely flowing to damage the boost unit 140A by the second protection diode Dp2, and provides a path of current flowing through the first switch S1 by the first protection diode Dp1.

Please refer to FIG. 3A, and refer also to FIGS. 1-2. A step-up DC-to-DC converter is used for example, the relation between the output voltage and the input voltage is: Vo=(D/(1−D))×(N2a/N1a)×Vin, wherein D is a duty cycle of the first control signal Sc1 of the boost unit 140, N2a/N1a is the turn ratio between the second coil N2a and the first coil N1a. Specifically, if the step-up DC-to-DC converter of the boost unit 140 of the present invention is not used, the output voltage will be limited and the input voltage thus has the boost ratio relation: Vo=(1/(1−D))×Vin, and the DC input voltage Vin only can be boosted to be no more than two times. The present invention by the relation of the turn ratio between the second coil N2a and the first coil N1a and the relation of the aforementioned boost ratio, thus the DC input voltage Vin can be boosted to be much more than two times. In other words, the step-up DC-to-DC converter of the boost unit 140 of the present invention has a boost ratio greater than that of the traditional converter. Therefore, the boost unit 140 of the present invention largely boosts the DC input voltage Vin lower than that of the traditional converter to make the DC output voltage Vo be higher than the predetermined voltage Vp, and the hold-up time T may thus be extended to maintain the DC output voltage Vo for normal power supply.

It should be noted that, in the embodiment, a subtractive polarity transformer topology may be formed by appropriately connecting dotted and non-dotted positions of the first coil N1a and those of the second coil N2a, but not limited. In other words, the first coil N1a and the second coil N2a may also form an additive polarity transformer topology. When the first coil N1a and the second coil N2a may form the additive polarity transformer topology, a rectifying unit (not shown) or polarity holding circuit (not shown) is needed to be connected at rear of the boost unit 140A to hold the polarity of the DC output voltage Vo converted from the DC input voltage Vin equal to that of the DC output voltage Vo at the second capacitor C2.

Please refer to FIG. 3B, which shows a circuit diagram of the boost unit according to a second embodiment of the present invention. Refer also to FIG. 1, the boost unit 140B of the embodiment differs from the boost unit 140A of the first embodiment in that the first coil N1a′ and the second coil N2a′ form an auto transformer topology. The first coil N1a′ is located at the primary side 142′, the first coil N1a′ is coupled to first capacitor C1 at one end of the first coil N1a′, and coupled to the first switch S1 at the other end. The second coil N2a′ is located at the secondary side 144′, the second coil N2a′ is coupled to first coil N1a′ at one end of the second coil N2a′, and coupled to the second capacitor C2 at the other end. Based on the characteristic of the auto transformer topology, the turn ratio between the second coil N2a′ and the first coil N1a′ is: (N2a′−N1a′)/N1a′>1. That is, the turn ratio between the turn difference of the second coil N2a′ and the first coil N1a′ and the first coil N1a′ is the boost ratio Mb. The boost unit 140B of the embodiment, compared with that of the boost unit 140A of the step-up DC-to-DC power converter shown in FIG. 3A, the boost ratio of the boost unit 140B is: Vo=(D/(1−D))×[(N2a′−N1a′)/N1a′]×Vin. Therefore, the DC input voltage Vin may be largely boosted by the boost unit 140B to maintain the DC output voltage Vo for normal power supply. As mentioned in the boost unit 140A of the first embodiment, the descriptions of the boost unit 140B, the dotted position and performance of the first coil N1a′ and second coil N2a′, the connection and function of the first protection diode Dp1 and the second protection diode Dp2, and the control of the detection control unit 160 to the boost unit 140B are not repeated here.

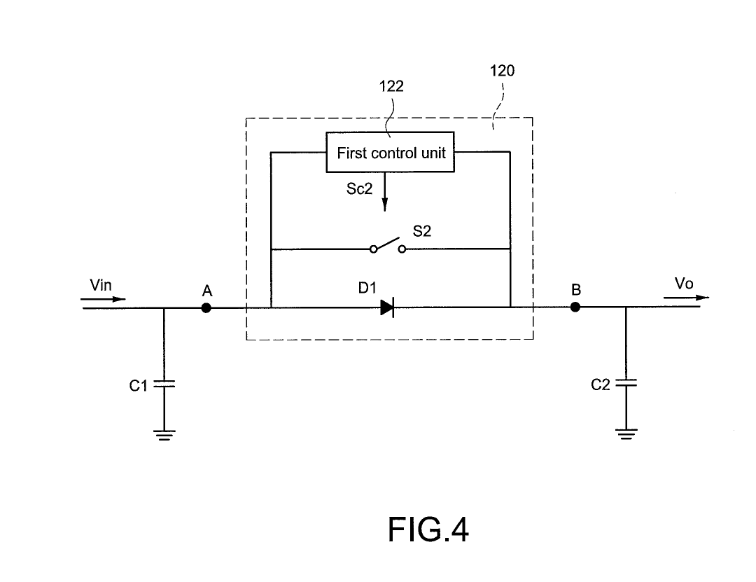

Please refer to FIG. 4, which shows a circuit diagram of a bypass unit according to the present invention. Refer also to FIG. 1, the bypass unit 120 includes the first diode D1, the second switch S2 and a first control unit 122. An anode of the first diode D1 is the input end A of the bypass unit 120, and a cathode of the first diode D1 is the output end B of the bypass unit 120. The second switch S2 and the first control unit 122 are both coupled to the first diode D1 in parallel, and the first control unit 122 controls the second switch S2 in connection or disconnection according to the DC input voltage Vin and the DC output voltage Vo. When the DC input voltage Vin is higher than the DC output voltage Vo, the first control unit 122 outputs a second control signal Sc2 with a high level to connect (turn on) the second switch S2 so that the bypass unit 120 provides a path for transmitting power from the DC input voltage Vin to the DC output voltage Vo. When the DC input voltage Vin is lower than the DC output voltage Vo, the first control unit 122 outputs the second control signal Sc2 with a low level to disconnect the second switch S2.

Specifically, when the DC input voltage Vin is higher than the DC output voltage Vo, the first diode D1 is forward biased, but the internal resistance of the first diode D1 is higher than that of the second switch S2 in turned on, therefore when the DC input voltage Vin is higher than the DC output voltage Vo, the DC input voltage Vin is transmitted to the second capacitor C2 by the path of the second switch S2 in turned on. When the DC input voltage Vin is lower than the DC output voltage Vo, the first diode D1 is reverse biased, and the first control unit 122 turns off the second switch S2, the bypass unit 120 is thus disconnected. That is, the DC input voltage Vin cannot be transmitted to the second capacitor C2 through the bypass unit 120. Furthermore, the second switch S2 and the first control unit 122 may be an O-ring transistor, therefore a single O-ring transistor may be controlled without any controller and only by self-driving through detecting the DC input voltage Vin and the DC output voltage Vo. Therefore, through the O-ring transistor of the embodiment, the second boost circuit 100 may not need a controller added, such as the first control unit 122 is used for controlling the bypass unit 120, and thus saving the circuit costs and volume, and simplifying control designs.

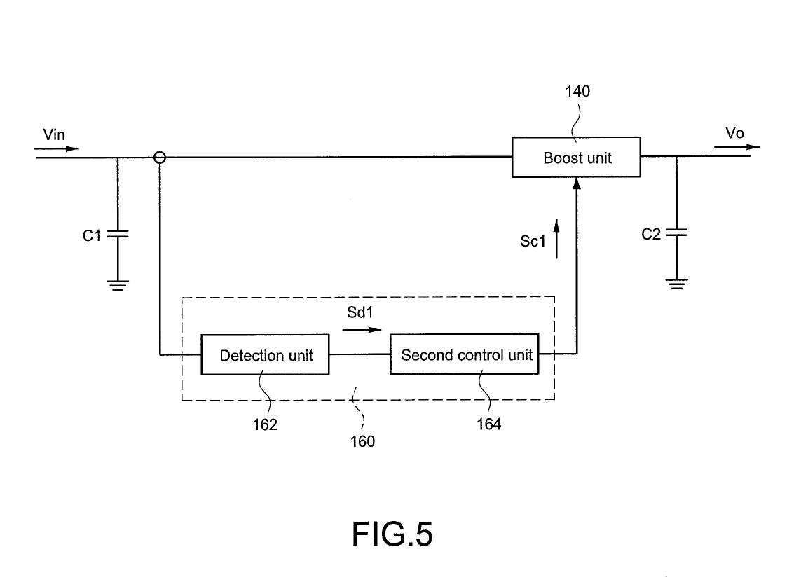

Please refer to FIG. 5, which shows a circuit block diagram of a detection control unit according to the present invention. Refer also to FIGS. 1, 3A-3B, the detection control unit 160 includes a detection unit 162 and a second control unit 164. The detection unit 162 is coupled to the first capacitor C1, and the detection unit 162 detects the DC input voltage Vin and outputs a first detection signal Sd1 to the second control unit 164 according to the DC input voltage Vin. The second control unit 164 is coupled to the detection unit 162 and the boost unit 140. The second control unit 164 outputs the first control signal Sc1 to the first switch S1 of the boost unit 140 to switch (continuously turn on and turn off) the first switch S1 according to the first detection signal Sd1. When the DC input voltage Vin is lower than the threshold voltage Vt, the second control unit 164 outputs the first control signal Sc1, or outputs the first control signal Sc1 with an enabled level (such as a high level) to the boost unit 140 to control the boost operation of the boost unit 140. When the DC input voltage Vin is higher than or equal to the threshold voltage Vt, the second control unit 164 does not output the first control signal Sc1, or outputs the first control signal Sc1 with a disabled level (such as a low level) to the boost unit 140, thereby disabling the boost unit 140.

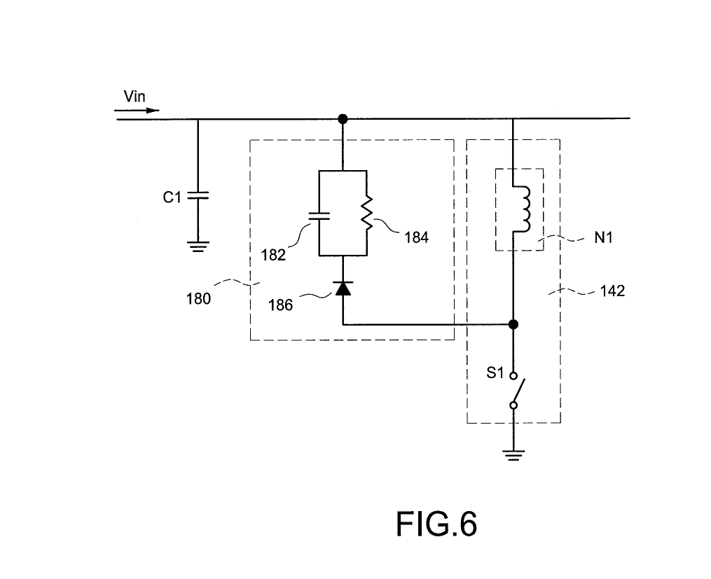

Please refer to FIG. 6, which shows a circuit diagram of a buffer circuit according to the present invention. Refer also to FIGS. 1, 3A-3B, the second boost circuit 100 further includes a buffer circuit 180, the buffer circuit 180 is coupled to the boost unit 140 and the first capacitor C1 to restrain an impulse voltage generated from the boost unit 140 during operation. Specifically, the buffer circuit 180 includes a capacitor 182, a resistor 184 and a second diode 186. The capacitor 182 is coupled to the first capacitor C1, and the resistor 184 is coupled to the capacitor 182 in parallel. A cathode of the second diode 186 is coupled to the capacitor 182 and the resistor 184, and an anode of the second diode 186 is coupled to the first switch S1 and the first inductive element N1 of the boost unit 140. When the boost unit 140 operates and generates the impulse voltage, the resistor 182 and the capacitor 184 are provide to restrain a voltage peak value of the impulse voltage. It needs to be noted that in the embodiment, the buffer circuit 180 is not limited to the above implementation, as long as the buffer circuit 180 may restrain the voltage peak value of the impulse voltage, it is within the scope of the embodiment.

Specifically, when the DC input voltage Vin is lower than the threshold voltage Vt, the second control unit 164 outputs the first control signal Sc1 to the first switch S1. At this condition, the first switch S1 is turned on or turned off according to high or low level of the first control signal Sc1. When the first control signal Sc1 is high level and the first switch S1 is turned on, the first switch S1 generates the impulse voltage while being turned on. If the voltage peak value of the impulse voltage exceeds the maximum voltage that the first switch S1 can bear, the first switch S1 is thus damaged. Therefore, the present invention uses the buffer circuit 180 to restrain the voltage peak value of the impulse voltage generated while the first switch S1 is turned on to avoid damaging the first switch S1.

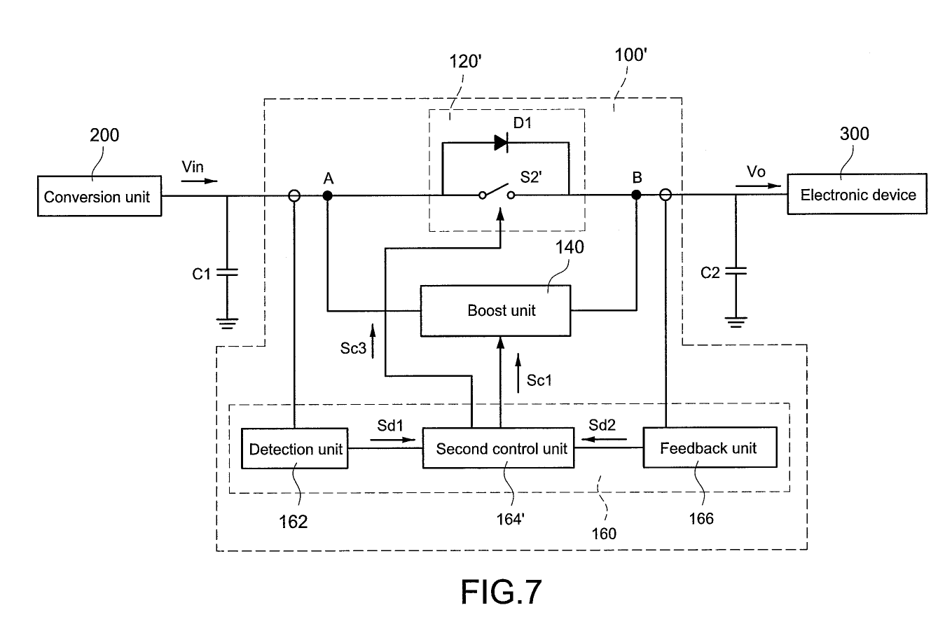

Please refer to FIG. 7, which shows a circuit block diagram of the second boost circuit according to the second embodiment of the present invention. Refer also to FIGS. 1, 4-5. The second boost circuit 100′ of the embodiment differs from the second boost circuit 100 of the first embodiment in that, the second switch S2′ of the bypass unit 120′ in the second boost circuit 100′ is a transistor without self-driving turned on or turned off. The detection control unit 160′ includes a feedback unit 166, the feedback unit 166 is coupled to the second capacitor C2 and a second control unit 164′. The feedback unit 166 detects the DC output voltage Vo and outputs a second detection signal Sd2 to the second control unit 164′ according to the DC output voltage Vo. The second control unit 164′ compares the first detection signal Sd1 with the second detection signal Sd2 to determine whether the DC input voltage Vin is higher than the DC output voltage Vo. When the DC input voltage Vin is higher than the DC output voltage Vo, the second control unit 164′ outputs a third control signal Sc3 with a high level to the second switch S2′ to turn on the second switch S2′. When the DC input voltage Vin is lower than the DC output voltage Vo, the second control unit 164′ outputs the third control signal Sc3 with a low level to the second switch S2′ to turn off the second switch S2′. It should be noted that in the embodiment, the second switch S2′ is not limited to be a transistor. In other words, as long as a switch connects or disconnects the third control signal Sc3, it is within the scope of the embodiment. The description for the connection and control of the rest elements of the second boost circuit 100′, equal to the second boost circuit 100 of the first embodiment, is not repeated here.

It should be noted that in the present invention, the control signal with high or low levels only connects or disconnects the switch, therefore the control signal is not limited to be of high level to connect the switch in the present invention. For example, but not limited, the switch may also be connected by the control signal of low level. Besides, in the present invention, the first and second embodiment of the boost unit in FIG. 3A-FIG. 3B, and the buffer circuit in FIG. 6 are compatible with the first and second embodiments of the second boost circuit in FIG. 7.

In summary, one or more embodiments of the present invention have at least one of the following advantages:

1. When the DC input voltage decrease to below the threshold voltage, the second boost circuit maintains the DC output voltage higher than the predetermined voltage during the hold-up time. Therefore, the DC input voltage and the DC output voltage may be prevented from decreasing too fast, thereby avoiding damaging the rear-stage electronic device due to the abnormal DC output voltage.

2. The second boost circuit during the hold-up time maintains the DC output voltage higher than the predetermined voltage so that the second boost circuit provides the DC output voltage higher than the predetermined voltage during the hold-up time after the DC input voltage is off. Therefore, the rear-stage electronic device is allowed to completely store or backup data during the hold-up time.

3. The second boost circuit may maintain the DC output voltage higher than predetermined voltage during the hold-up time, and thus the first capacitor and the second capacitor with greater capacitance are not required to prevent the DC input voltage and the DC output voltage from decreasing fast. In this way, the size and the volume of the first capacitor and the second capacitor may be smaller, and the circuit volume of the front-stage coupled conversion unit and the rear-stage electronic device may be further smaller.

4. The boost unit avoids the current reversely flowing to damage the boost unit by the second protection diode, and provides a path of current flowing through the first switch by the first protection diode.

5. By the properly designed boost ratio, the boost unit of the present invention largely boosts the DC input voltage lower than that of the traditional converter to make the DC output voltage be higher than the predetermined voltage, and the hold-up time may thus be extended to maintain the DC output voltage for normal power supply.

6. The boost unit of the present invention still may largely boost the DC input voltage of lower value to maintain the DC output voltage normal for power supply, therefore the voltage variation tolerance and voltage stability is high.

7. By match design of the boost ratio and the duty cycle of the first control signal, the boost unit may thus satisfy both high conversion efficiency and high boost ratio.

8. The bypass unit of the present invention uses only a single O-ring transistor detecting the DC input voltage and the DC output voltage and connecting or disconnecting by self-driving, thus the second boost circuit may not need a controller added so as to save the circuit costs and volume, and simplify control designs.

9. The second boost circuit of the present invention includes the buffer circuit to decrease the voltage peak value of the impulse voltage generated while the first switch being connected, therefore the first switch may be protected.

Although the present invention has been described with reference to the preferred embodiment thereof, it will be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

1. A second boost circuit used for a DC voltage input, the second boost circuit comprising:
a bypass unit having an input end and an output end, the input end being coupled to a first capacitor, the output end being coupled to a second capacitor, wherein the first capacitor is configured to receive a DC input voltage;
a boost unit having a primary side and a secondary side, the primary side being coupled to the first capacitor, the secondary side being coupled to the second capacitor, wherein the primary side has a first inductive element, the secondary side has a second inductive element, and a boost ratio is provided between the second inductive element and the first inductive element to make the boost unit perform a boos operation; and
a detection control unit configured to detect the DC input voltage;
wherein when the DC input voltage is lower than a threshold voltage, the bypass unit is disconnected, and the detection control unit is configured to control the boost unit to convert the DC input voltage into a DC output voltage according to the boost ratio.

2. The second boost circuit of claim 1, wherein the detection control unit is configured to control the boost unit to maintain the DC output voltage higher than a predetermined voltage during a hold-up time.

3. The second boost circuit of claim 1, wherein when the DC input voltage is higher than or equal to the threshold voltage, the bypass unit is connected, and the detection control unit is configured to disconnect the boost unit so that the DC input voltage is provided to the DC output voltage.

4. The second boost circuit of claim 1, wherein the boost unit comprises:
a first switch;
a first coil located at the primary side, and the first coil coupled to the first capacitor at one end of the first coil and coupled to the first switch at the other end of the first coil; and
a second coil located at the secondary side, and the second coil coupled to the first coil at one end of the second coil and coupled to the second capacitor at the other end of the second coil;
wherein the first coil and the second coil form an auto transformer topology, a turn ratio between a turn difference of the second coil and the first coil turn and the first coil turn is the boost ratio, when the detection control unit is configured to output a control signal to control the first switch, therefore the DC input voltage is boosted to be the DC output voltage based on the turn ratio.

5. The second boost circuit of claim 1, wherein the bypass unit comprises:
a first diode coupled to the first capacitor at one end of the first diode and coupled to the second capacitor at the other end of the first diode;
a second switch coupled to the first diode in parallel; and
a first control unit coupled to the first diode in parallel;
wherein the first control unit is configured to turn on or turn off the second switch according to the DC input voltage and the DC output voltage; when the DC input voltage is higher than the DC output voltage, the first control unit is configured to turn on the second switch; when the DC input voltage is lower than the DC output voltage, the first control unit is configured to turn off the second switch.

6. The second boost circuit of claim 1, wherein the detection control unit comprises:
a detection unit coupled to the first capacitor; and
a second control unit coupled to the detection unit and the boost unit;
wherein the detection unit is configured to detect the DC input voltage and output a detection signal to the second control unit according to the DC input voltage, and when the DC input voltage is lower than the threshold voltage, the second control unit is configured to output a control signal to the boost unit.

7. The second boost circuit of claim 1, wherein the boost unit comprises:
a first switch;
a first coil located at the primary side, and the first coil coupled to the first capacitor at one end of the first coil and coupled to the first switch at the other end of the first coil; and
a second coil located at the secondary side, and the second coil coupled to the second capacitor;
wherein the first coil is isolated from the second coil, a turn ratio between the second coil and the first coil is the boost ratio; when the detection control unit is configured to output a control signal to turn off the first switch, the DC input voltage is boosted to be the DC output voltage based on the turn ratio.

8. The second boost circuit of claim 7, wherein the first coil and the second coil form a subtractive polarity transformer topology.

9. The second boost circuit of claim 1, the second boost circuit further comprises:
a buffer circuit coupled to the boost unit and the first capacitor, and the buffer configured to restrain an impulse voltage generated from the boost unit.

10. The second boost circuit of claim 9, wherein the buffer circuit comprises:
a capacitor coupled to the first capacitor;
a resistor coupled to the capacitor in parallel; and
a second diode coupled to the capacitor and the boost unit;
wherein when the boost unit is configured to generate the impulse voltage, the resistor and the capacitor are provided to restrain a voltage peak value of the impulse voltage.
